(19) United States
(12) Patent Application Publication
(10) Pub. No.: US 2014/0189799 A1
(43) Pub. Date: Jul. 3, 2014

(54) MULTI-FACTOR AUTHORIZATION FOR AUTHORIZING A THIRD-PARTY APPLICATION TO USE A RESOURCE

(71) Applicant: GEMALTO SA, Meudon (FR)

(72) Inventor: HongQian Karen Lu, Austin, TX (US)

(73) Assignee: GEMALTO SA, Meudon (FR)

(21) Appl. No.: 13/729,070

(22) Filed: Dec. 28, 2012

(51) Int. Cl. H04L 29/06

(52) U.S. Cl. CPC H04L 63/08
USPC 726/4

(57) ABSTRACT

Enhanced security for limited access through multi-factor authorization to cloud computing resources. The enhanced security is obtained by utilizing a personal security device to perform certain security operations as part of an authorization protocol such that an authorization grant is confirmed using two independent factors such as evidence of knowledge of a secret plus possession of a personal security device. The personal security device may also store an access token and perform cryptographic operations evidencing possession of the access token. Other systems and methods are disclosed.

### BACKGROUND OF THE INVENTION

The present invention relates generally to access control for cloud resources, and more particularly to multifactor authorization for limited access control.

Computer users and organizations are increasingly turning to cloud computing for managing digital data and services, and for using such digital data and services. Cloud computing refers to using networked computing resources to provide digital services including data storage and digital services. Resources in the cloud include data, computing resources (e.g., virtual machines, virtual networks, etc.), digital services, and others.

There are many ways to use cloud services and some of these require interaction between different cloud services that may include using a resource managed by one cloud service with another cloud service. For example, a user may store photographs on photo-sharing sites such as Flickr or Picasa and may turn to a print service for producing Christmas cards from select photos managed by the photo-sharing site. In that scenario, a user has a resource (one or more digital photographs) on a resource server (Flickr or Picasa) and asks a client application (the print service) to access the resource.

In the above scenario, the client application requires access to the resource. If the resource server protects the digital assets stored thereon with some form of authentication mechanism, the client application must be given the requisite credential to access the resource. Traditionally, access to user accounts on resource servers relies on the username password paradigm. A user is asked for username and password and if what a user enters can be verified as correct username and password, the user is permitted access.

Consider now the Christmas card application. Typically a family will select only one or two, perhaps three, photographs to be placed on the family Christmas card. However, the username and password of the family's photo library would give the holder of those credentials access to the user's entire digital photography library stored on the resource server. That may be very undesirable to the user. In many other scenarios, where a cloud resource server houses highly confidential documents or digital services for a user, it may go beyond undesirable to allow a third-party client application to have access to the user's entire file system stored on the resource server.

The hereinabove discussed problem in cloud computing is addressed by the OAuth standard and other authorization protocols. The OAuth authorization framework provides users mechanisms to grant third-party client applications limited access to resources stored on a resource server without sharing the users' credentials. The authorizations provided through the OAuth framework can be limited to particular resources and limited in duration.

The OAuth framework provides a protocol by which a resource client application may ask a user to grant the resource authorization for particular resources. Given that online resources may contain highly sensitive information, it is very important to ensure that access is secure and protected from impermissible access.

Due to the risks and complexity of authorization, the openness of the Internet, and the desires of simplicity and ease of deployment, authorization protocols, for example, OAuth 2.0, face a large amount of threats. T. Lodderstedt, et al. “OAuth 2.0 threat model and security considerations,” Oct. 26, 2011, 65 pages, http://tools*ietf*org/html/draft-ietf-oauth-v2-threatmodel-01¹, accessed on Dec. 13, 2012. These threats include: ¹To avoid having impermissible functioning hyperlinks in this document, periods (“.”) in urls are replaced with asterisks (“*”). Thus, each asterisk should be replaced with a period when accessing the referenced site.

Malicious client obtains existing authorization by fraud

Eavesdropping access tokens at rest or on transport

Malicious client obtains authorization

User session impersonation

Resource owner impersonation

More specifically, with the current mechanism, if a user's credential (such as username/password) is stolen, the attacker with the credential can authorize any malicious clients to access the victim's resources by simply granting the authorization in the authorization user interface provided by the authorization server or even doing so in an automatic way. If an access token is stolen, the malicious client would be able to access the user's resource without the user being aware of that breach of intended access restriction on the resource.

From the foregoing it is apparent that there is a need for an improved method for securing authorization protocols to reduce the risk of a credential being misappropriated.

### BRIEF DESCRIPTION OF THE DRAWINGS

FIG. 1 is a block diagram illustrating a computer network having a host computer operated by a user and a personal security device attached thereto, a resource server hosting a resource library on behalf of the user, an authentication server, and an authorization server.

FIG. 2 is a schematic illustration of software programs corresponding to the hardware nodes of FIG. 1 and further illustrating logical communications connections between processes running these software programs on their respective hardware nodes.

FIG. 3 is a block diagram illustrating a high-level view of the architecture of the personal security device of FIG. 1.

FIG. 4 is a block diagram illustrating the architectural organization of programs over the hardware components of the personal security device of FIG. 2, including illustrating a card user agent both stored in memory of the personal security device.

FIG. 5 is an illustration of a prior art protocol flow for a limited authorization to a resource according to one implementation of the OAuth framework.

FIG. 6 is a timing sequence diagram illustrating a first message flow to enhance the security of the protocol flow of FIG. 5 using a personal security device.

FIG. 7 is a timing sequence diagram illustrating an alternative message flow to enhance the security of the protocol flow of FIG. 5 using a personal security device.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a powerful yet economical and flexible technology is presented that enhances security of limited access authorization to cloud resources. This technology includes the use of a personal security token in the authorization protocol. The personal security token may be used for one or more of secure storage or access tokens, providing a heightened level confidence that an authorized user authorizes a limited access to a resource, and providing cryptographic operations as part of the authorization protocol.

User authentication and authorization, while similar in name, are in fact different concepts. Authentication is the concept of verifying identity of a user so that access to a resource is not given to the wrong person. Authorization, on the other hand, is a mechanism with which an authority (e.g., the resource owner) grants permission to a particular party to perform a certain action on a specified resource. To heighten the security associated with authentication, multi-factor authentication may be employed. Multi-factor authentication is based on the concept of authenticating a user using multiple factors. An example of a single factor authentication would be using the username-password combination; the user is authenticated by what the user knows, the password. Two-factor authentication may be based on ensuring that the user is in possession of a token, a personal security device, e.g., a smart card, in addition to a Personal Identification Number (PIN); the user is authenticated based on what the user is in possession of and what the user knows. Additional authentication factors may be included in the authentication mechanism, such as biometrics, user location, and context. Authentication with more than one factor is called multi-factor authentication.

According to a preferred embodiment, authorization is also provided with a multi-factor mechanism, e.g., the user authorizes the use of a resource and that authorization is confirmed to be authentic by demonstrating that the user knows a password (or other similar mechanism) or is confirmed using a biometric, and by demonstrating possession of a personal security device.

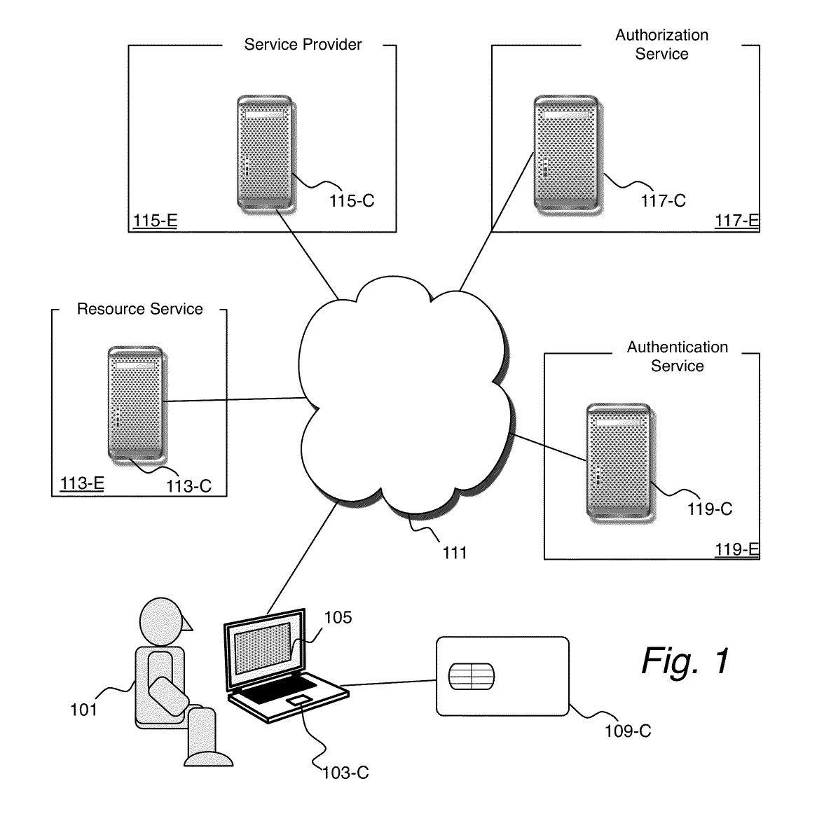

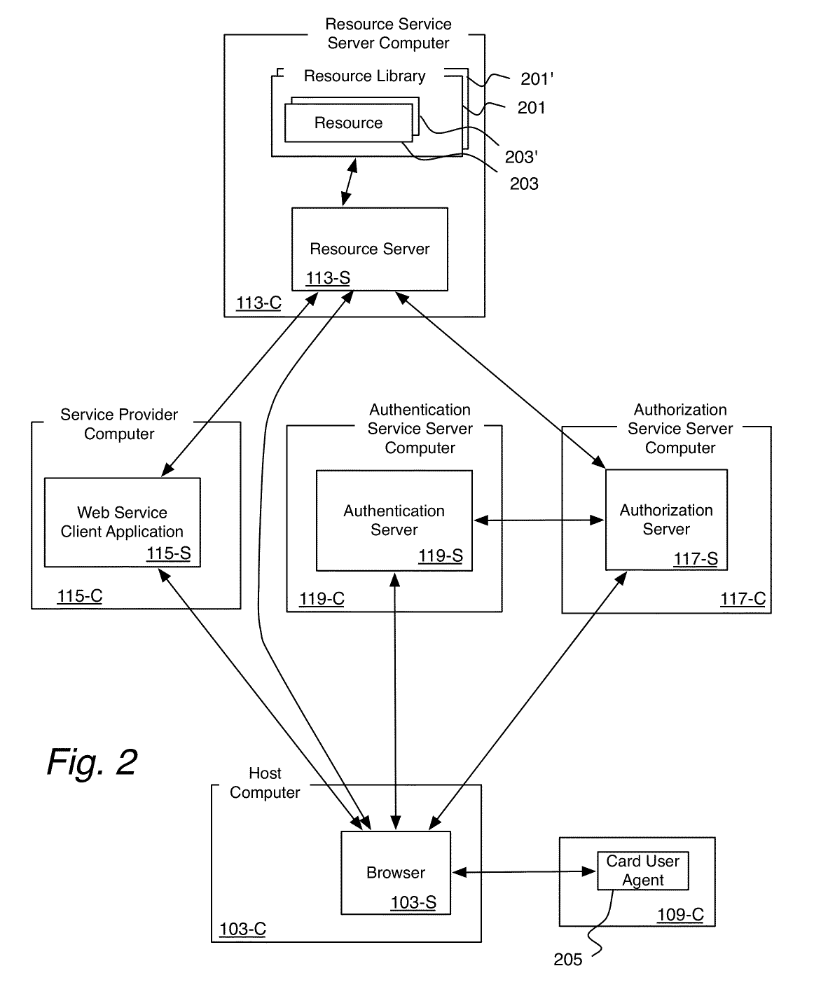

FIG. 1 is a block diagram illustrating a computer network 111 having a host computer 103-C² operated by a user 101 and a personal security device 109-C attached thereto, a resource service server computer 113-C on which a resource service 113-E hosts a resource library (illustrated in FIG. 2) on behalf of the user 101, an authentication service 119-E operating an authentication server computer 119-C, and an authorization service 117-E operating an authorization server computer 117-C wherein the personal security device 109 is utilized to enhance the confidence in authenticity of a user authorization to use a resource. The user may access network resources using a web browser program (illustrated in FIG. 2) displaying a web-browser window 105 on the user's host computer 103-C. ²In this description several related elements are referred to a n-E, n-C, and n-S, respectively. E stands for entity, C, for computer, and S, for software. Thus, n-E is the entity n-E, that operates the computer n-C, which executes according to instructions n-S. For example, Service Provider 115-E operates a computer 115-C which executes a web service 115-S. For ease of description, we sometimes refer to these elements by the number n, e.g., service provider 115. Unless the context makes the contrary clear, this should typically be taken to mean that a reference to all three elements performing their respective roles, e.g., that the service provider computer 115-C performs some action prescribed by the software in the web service program 115-S.

A network 111 connects the host computer 105 to a network 111, e.g., the Internet, that also has a resource service 113-E operating a resource service server computer 113-C connected thereto. The resource service is a cloud computing service that stores information on behalf of the user 101. For example, the resource service could be a service such a Flickr or Picasa, services for storing photographs on behalf of their users, or an in-the-cloud backup server that is used as backup storage for the host computer 103-C.

A resource service 113 typically protects user contents through an authentication mechanism requiring a user to produce an authentication credential, e.g., username/password.

Also connected to the network 111 is a service provider 115-E. The service provider operates a service that may need limited access to user resources hosted by the resource service 113. An example would be a service that produces hardcopy books of select photographs that the user stores at the resource service 113. If the user 101 desires to transfer photographs directly from the resource service 113 to the service provider 115 (e.g., without downloading the photographs to the host 103 and then uploading them to the service provider) authentication credentials must be provided.

According to a preferred embodiment discussed in greater detail herein below, the user 101 provides the service provider 115 with a limited purpose credential (e.g., in the style of OAuth) with an enhanced level of security using an authentication service 119-E operating an authentication server computer 119-C, an authorization service 117-E operating an authorization server computer 117-C, and a personal security device 109-C.

Each of computers 103-C, 115-C, 117-C, and 119-C may have typical components of a computer, e.g., a central processing unit capable of executing instructions stored on a storage device and memory used during execution of programs. Details of such architectures are generally known and not necessary to the understanding of the present discussion. In one scenario, the computers n-C have their respective software programs n-S stored on a storage device of the computer n-C. An operating system of the computer n-C loads the software program n-S to be executed by the processor of the computer n-C. Herein, language such as “web browser 103 sends a message X to service provider 115” is used as a short-hand description of the actions taken by the various processors executing program instructions. Thus, the example phrase in the previous sentence could be interpreted to mean that the software instructions of the web browser 103-S is executed to cause the processor of the host computer 103-C to transmit the message X to the service provider server computer 115-C which operates under the instructions of the web service program 115-S.

FIG. 2 is a schematic illustration of software programs corresponding to the hardware nodes of FIG. 1 and further illustrating logical communications connections between processes running these software programs on their respective hardware nodes.

The user 101 interacts with entities over the Internet via the user agent that may include user's web browser 103-C, smart card 109, and other hardware or software acting on the user's behalf

The resource service server computer 113-C includes a resource server application 113-S. The resource server application 113-S provides a mechanism by which the user 101 operates a web browser 103-S on the host computer 103-C to store and access resource libraries 201. There may be one resource library per user or a user may have access to more than one resource library 201. Typically, however, one user credential would be associated with one resource library wherein logging in to the resource library 201 will give the user full access to the contents of the library. However, various access control mechanisms can be employed to give different users and groups of users varying degree of access for a library.

A resource library 201 contains one or more resources 203. A resource 203 may be one file in a file system, e.g., one document or one photograph, or a collection of files, e.g., a folder with multiple documents or a slideshow of photographs. In the context of the present discussion, which object, how many objects, the type of objects, and how the objects are organized to form a resource is not important.

In the context of the present discussion, a client application 115-S, for example, but not limited to, a Web service client application or a local application running in a browser on a host computer or on a mobile device, (hereinafter sometimes referred to simply as the client application or client) seeks to access a particular resource 203. Note: for the present discussion, as discussed above, a resource can be any grouping of data, other objects or services, a user controls on the resource server 113. Thus, for example, if the user 101 wishes to have the client application access three related documents, they may be considered as one resource. Conversely, the three files may be considered separate resources and an access authorization (discussed below) may grant access to multiple resources.

To obtain the limited access discussed herein, the client application 115 is logically connected to an authentication server 119-S and an authorization server 117-S which execute on authentication service server computer 119-C and authorization service server computer 117-C, respectively.

To obtain a heightened level of security in limited authorization grants, the personal security device 109-C, which may be executing a software program, referred to herein as the card user agent 205, may be used to provide limited access authorization on behalf of the user 101 and to store, encrypt and sign access tokens.

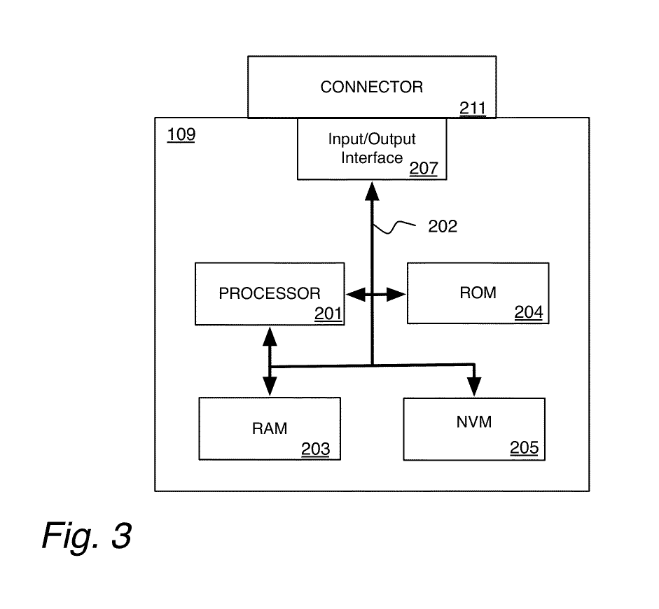

FIG. 3 is a schematic illustration of a personal security device 109, for example, a smart card. The portable security device 109 may include a processor 201 connected via a bus 202 to a random access memory (RAM) 203, a read-only memory (ROM) 204, and a non-volatile memory (NVM) 205. The portable security device 109 further includes an input/output interface 207 for connecting the processor 201, again typically via the bus 202, to a connector 211 by which the portable security device 109 may be connected to the host computer 103.

In alternative embodiments, the connection between the host computer 103 and the portable security device 109 is wireless, for example, using near-field communication (NFC) or other radio or microwave communications technologies.

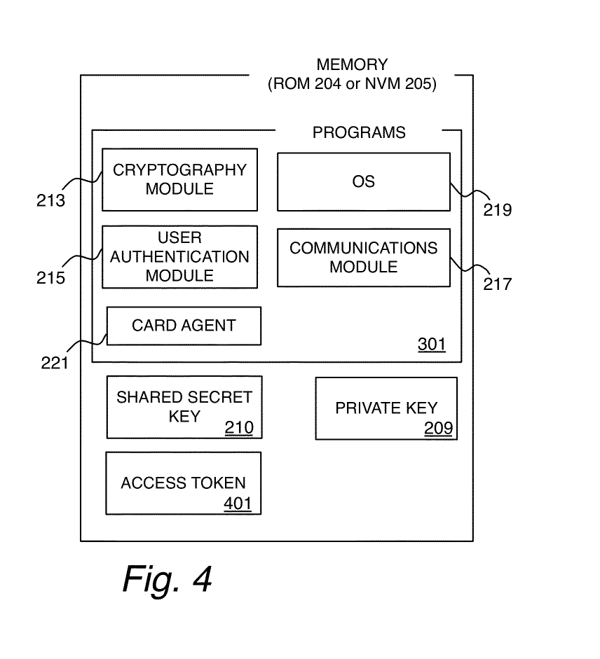

The NVM 205 and/or ROM 204 may include computer programs 301 as is illustrated in FIG. 4. While it is here depicted that the computer programs 301 are all co-located in the ROM 204 or the NVM 205, in actual practice there is no such restriction as programs may be spread out over multiple memories and even temporarily installed in RAM 203. Furthermore, the portable security device 109 may include multiple ROMs or NVMs. The programs 301 include operating system programs as well as application programs loaded on to the portable security device 109. The NVM 205 or ROM 204 may also contain private data, such as a private key 209 or a shared secret key 210, stored either in its basic form or in derived quantities.

The portable security device 109 programs 301 may include a cryptography module 213, a user authentication module 215, a communications module 217, and the operating system OS 219. The portable security device 109 programs 301 may further include a card agent 205 for causing the portable security device 109 to perform the tasks of the portable security device 109 described herein, for example, to negotiate an issuance and authorization of access tokens 401, to store access tokens, and to encrypt or sign access tokens.

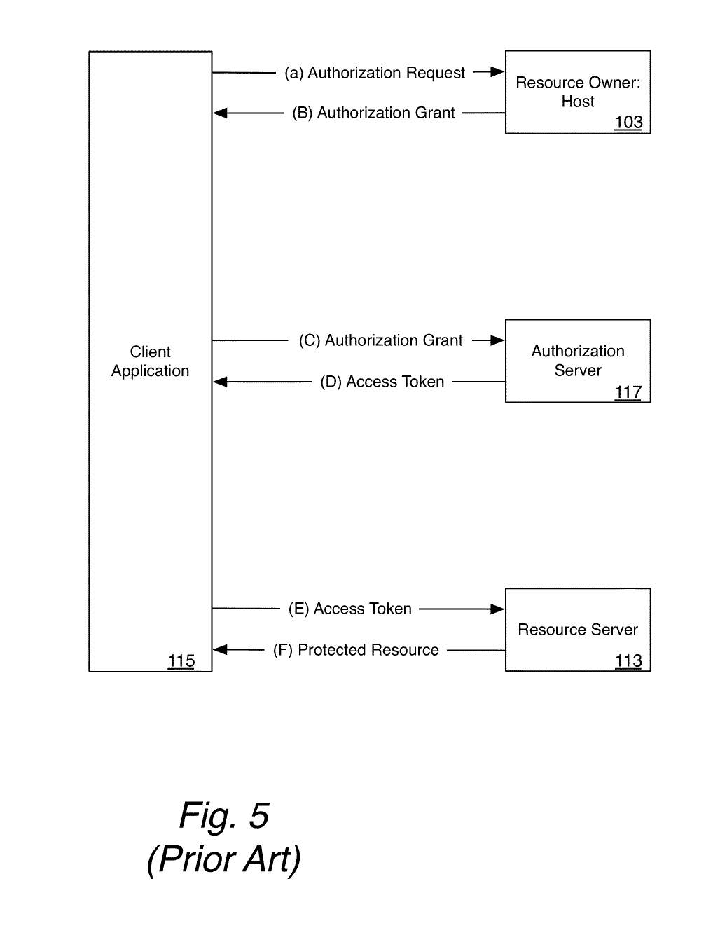

FIG. 5 (Prior Art) illustrates the protocol flow of OAuth 2.0 as described in D. Hardt, Ed., The OAuth 2.0 Authorization Framework, OAuth Working Group, Jul. 31, 2012, http://tools*ietf*org/pdf/draft-ietf-oauth-v2-31.pdf, accessed on Dec. 21, 2012, hereinafter Hardt, which is incorporated herein in its entirety by reference.

The OAuth protocol flow includes the following steps:

“(A) The client [115] requests authorization from the resource owner [103]. The authorization request can be made directly to the resource owner [103] (as shown), or preferably indirectly via the authorization server [117] as an intermediary.

“(B) The client [115] receives an authorization grant, which is a credential representing the resource owner's [101] authorization, expressed using one of four grant types defined in this specification or using an extension grant type. The authorization grant type depends on the method used by the client to request authorization and the types supported by the authorization server.

“(C) The client [115] requests an access token by authenticating with the authorization server [117] and presenting the authorization grant.

“(D) The authorization server [117] authenticates the client [115] and validates the authorization grant, and if valid, issues an access token.

“(E) The client [115] requests the protected resource [203] from the resource server [113] and authenticates by presenting the access token.

“(F) The resource server [113] validates the access token, and if valid, serves the request.” Hardt, 1.2 Protocol Flow (reference numerals consistent with present discussion added).

An authorization grant is a credential by which a resource owner authorizes a client to obtain an access code. OAuth 2.0 defines four types of authorization grants: authorization code, implicit, resource owner password credentials, and client credentials. The present discussion includes descriptions of enhanced process flows for authorization code and implicit, and other extension grant types that require the resource owner's authorization. The mechanisms described herein may be adapted to resource owner password credentials as well. Furthermore, while OAuth is used herein as an example environment for practicing the presented technology, it is by no means the only framework in which the technology may be used.

The above terms from OAuth are described in greater detail in Hardt,—Section 1.3.

The authorization code is obtained by using the authorization server 117 as an intermediary between the client application 115 and the resource server 113. The client application 115 directs the resource owner to the authorization server which in turn directs the resource owner back to the client with the authorization code. This exchange is predicated on authentication of the resource owner and obtaining authorization from the owner. The authentication is with the authorization server 117 and, thus, the client application is never made aware of any authentication credentials of the owner.

According to an embodiment presented herein, the personal security token 109 is used to verify that the user 101 intends to grant the requested authorization by authenticating the user 101 to the personal security token 109. The personal security token is further used to sign the authorization request to confirm that the user 101 has granted authorization.

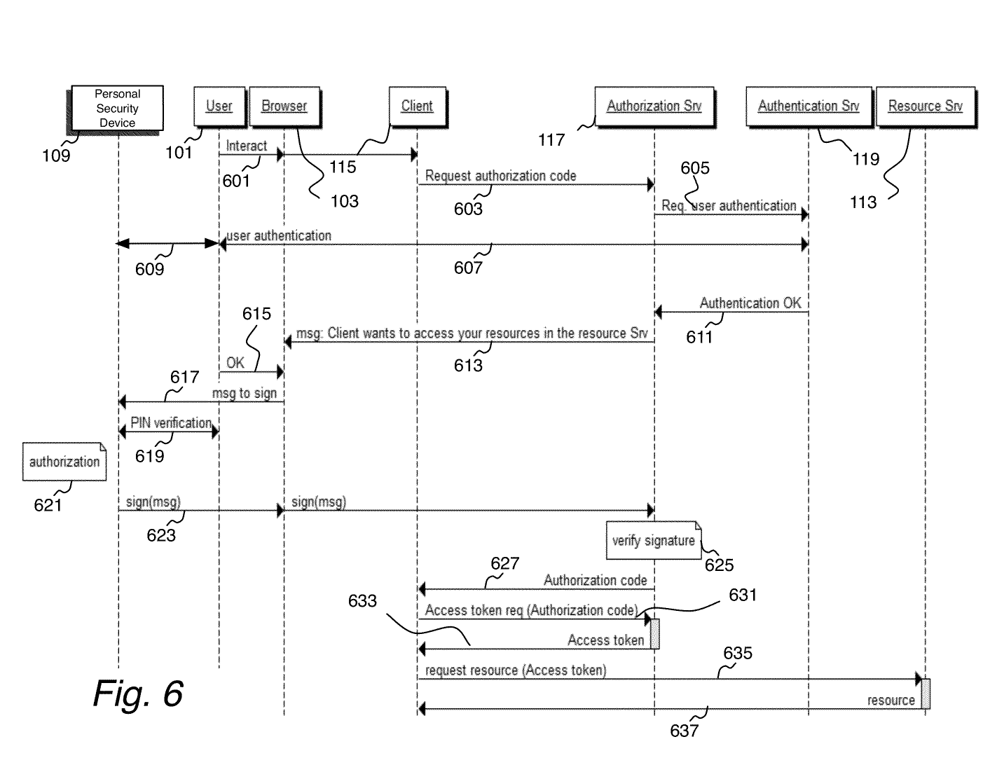

FIG. 6 is a timing sequence diagram illustrating the message flow to enhance the security of the protocol flow of FIG. 5 using a personal security device in a flow corresponding to the OAuth Code authorization type. In the Code authorization type the authorization code is obtained using an authorization server as an intermediary between the client and the resource owner. The client directs the resource owner to an authorization server, which in turn directs the resource owner back to the client with the authorization code.

Step 601: the user 101, using the browser 103, initiates an action with the client 115 requiring the client to obtain access to a protected resource 203.

Step 603: the client 101 requests an authorization code from the authorization server 117.

Step 605: the authorization server 117 requires authentication of the user 101 and turns to the authentication server 119 to obtain that authentication.

Step 607: the authentication server 119 interacts with the user 101 to authenticate the user 101. In some embodiments, this authentication dialog may also include the personal security device 109, step 609.

Step 611: presuming the authentication concluded with a positive authentication of the user 101, a message indicating that the authentication is OK is transmitted from the authentication server 119 back to the authorization server 117. The authorization server 117 is then able to trust the interaction with the browser 103.

Step 613: upon receiving the authentication OK message, the authorization server 117 transmits a message to the user 101, via the browser 103, that the client 115 has requested access to a particular resource 203 hosted by the resource server 113.

Step 615: the user 101, via the browser 103, indicates approval of granting the request. The browser 103, in response thereto, engages in a verification process with the personal security token 109.

Multi-factor authorization of the request is obtained at this point in the flow. Multi-factor authorization is based on the premise that the authorization process has multiple authorization factors, including (in the case of two-factor authorization): 1) it has been confirmed by the user 101 who demonstrates particular knowledge of something (e.g., the user authentication of step 607 as well as a PIN to log into the personal security device 109), and 2) the possession of something such a security-providing item is required to grant the authorization, e.g., being in possession of the personal security device 109 that has a key that may be used to digitally sign a request message thereby indicating approval of granting the request. To increase the security associated with the authorization process, additional authorization factors may be employed such as biometrics, e.g., by authenticating the user 101 with a biometric reader attached to the host computer 103.

Step 617: as the first step of obtaining a multi-factor authorization, i.e., that the authorization has been confirmed by the user using two independent mechanisms (knowledge of something and possession of something), a message confirming authorization by the user 101 is transmitted by the browser 103 to the personal security device 109.

Step 619: the personal security device 109, to independently confirm that the user wishes to grant the authorization request, engages in a PIN challenge to the user 101 via the browser 109. The user 101 enters the PIN to confirm approval of granting the request. For multi-factor authorization beyond two factors, additional factors may be obtained, e.g., a biometric reading confirming the identity of the user 101.

Step 621: the personal security device 109 signs the authorization message using an encryption key of the personal security device 109.

Step 623: the personal security device 109 transmits the signed authorization message to the authorization server 117 via the browser 103.

Step 625: the authorization server 117 verifies the signature on the received signed authorization message.

Step 627: if the signature is verified and the message indicates (as it would) that the user 101 has approved of granting the request the client 115 obtaining access to the resource 203, the authorization server 117 sends an authorization code to the client 115.

Step 631: in possession of the authorization code, the client 115 requests an access token from the authorization server 117.

Step 633: the authorization server 117 returns an access token corresponding to the request to the client 115.

Step 635: the client 115 transmits a resource request message for the required resource including the access token to the resource server 113.

Step 637: the resource server 113 processes the resource request and if the access token meets the requirements, responds by transmitting the required resource to the client 115.

Thus, the data flow of FIG. 6 provides a mechanism by which a personal security token 109 may be used to provide multi-factor authorization for use of a resource in a limited access authorization protocol such as OAuth. The multi-factors include, for example, both verification of knowledge of a fact (e.g., PIN to authenticate to the personal security device 109) as well as possession of the personal security device 109 that contains a credential by which a message request may be signed.

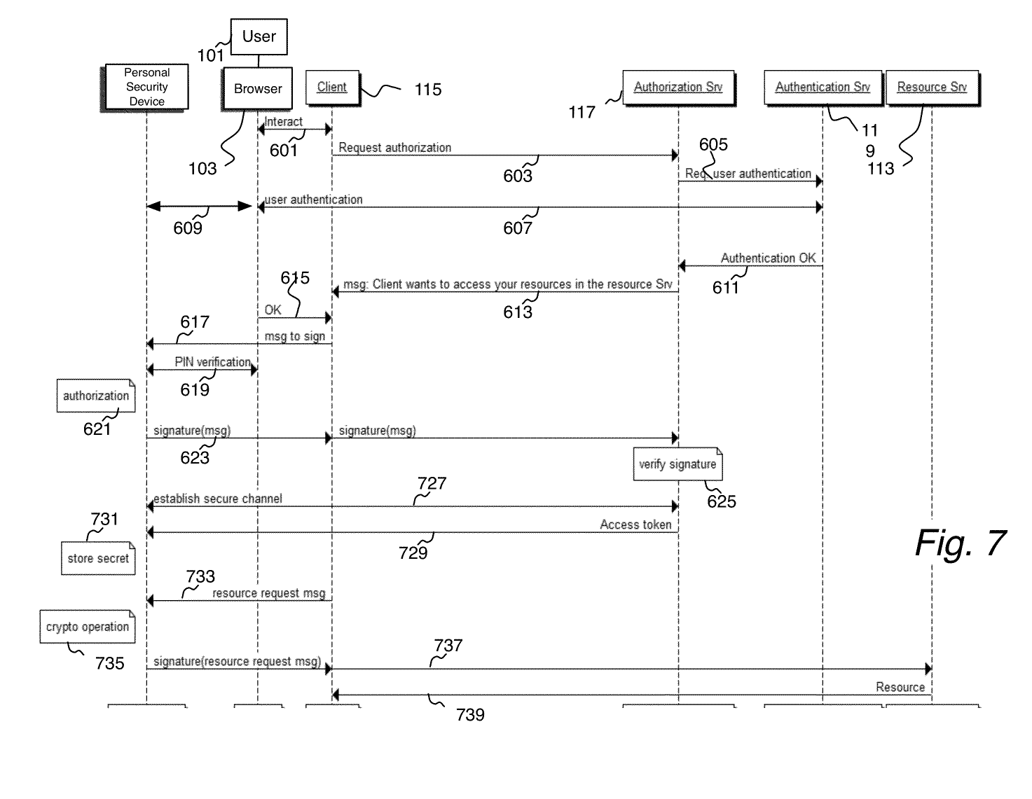

FIG. 7 illustrates a timing sequence flow for an alternative authorization mechanism, namely, one that corresponds to the OAuth Implicit authorization type. Up to Step 625 the flow is identical to the flow presented in and discussed in conjunction with FIG. 6. The description of those steps from above is incorporated here by reference.

Step 727: once the authorization server 117 has verified the signature with which the authorization message has been signed, the authorization server 117 establishes a secure communications channel to the personal security device 109. This secure communications channel may, for example, be an SSL/TLS channel.

Step 729: when a secure channel has been established, the authorization server 117 transmits the access token to the personal security device 109.

Step 731: The access token may have a time-restricted validity period within which the token must be used. The length of the period depends on the context. Practically, for convenience, the access token is often a long-term token that may be reused to authorize use of a resource. As such, the security of the long-term access token is critical to protect the resource because the token can be used to access the resource for a long time. To protect the access token, the personal security device 109 stores the token in its secure memory, e.g., in NVM 205.

There are two different types of such access tokens, bearer and proof tokens. A bearer token is one that may be used by anyone in possession (bearer) of the token to obtain access to the associated resource. This is inherently insecure as the token can easily or inadvertently be passed on to or otherwise obtained by a malicious user. However, by storing the bearer token in the personal security device 109, security is enhanced in that access to it may be limited by requiring authentication to the personal security device 109.

The proof token is more secure. A proof token has a secret associated with it. The client has to present a proof that it has the access token but without presenting the secret. A cryptographic operation is performed with the secret and the result is presented as the required proof. One example is the OAuth MAC token, described in E. Hammer-Lahav, HTTP Authentication: MAC Authentication, draft-hammer-oauth-v2-mac-token-02, Network Working Group, Jan. 22, 2011, tools*ietf*org/html/draft-hammer-oauth-v2-mac-token-02 accessed Dec. 19, 2012, the entire contents of which is incorporated herein by reference.

Step 733: the client 115 transmits a resource request message to the personal security device 109 requesting access to the protected resource. If the access token is a bearer token, the personal security device would return the access token to the client 115. This is not illustrated in FIG. 7.

Step 735: FIG. 7 rather illustrates the case where the access token is a proof token. Thus, when the personal security device 109 receives the resource request message, the personal security device performs the required cryptography operation, for example, computes a cryptographic hash on the request message, as described in the reference above. The hash is often called a signature.

Step 737: The personal security device 109 transmits the cryptographically signed resource request message to the resource server 113; the signed resource request message demonstrates possession of the access token secret (stored in Step 731) without actually revealing the secret associated with the access token.

Step 739: In response to receiving the signed resource request message, the resource server verifies the signature, which may be done via the authorization server, and, if successful, transmits the required resource to the client 115.

From the foregoing it will be apparent that a mechanism for achieving a higher level of security has been described for limited access authorization protocols such as OAuth.

Although specific embodiments of the invention have been described and illustrated, the invention is not to be limited to the specific forms or arrangements of parts so described and illustrated. The invention is limited only by the claims.

We claim:

1. A method for obtaining a multi-factor authorization authorizing a client application to access a resource controlled by a particular user and located on a resource server, comprising:
operating a personal authorization device associated with a particular user controlling a resource:
confirming that the user approves the grant of authorization to the client allowing the client access to the resource by authenticating the user to the personal authorization device;
upon confirming that the user approves the grant of authorization by authenticating the user to the personal authorization device, to certify the approval of the particular user to grant an authorization permitting the client to access the resource; and
issuing an authorization upon verifying the certification by the personal authorization device to the approval of the particular user to grant the authorization to access the resource.

2. The method for obtaining a multi-factor certification of an authorization authorizing a client application to access a resource controlled by a particular user and located on a resource server of claim 1 further comprising:
operating the personal authorization device to:
receive an access token issued by an authorization server upon having verified the certification by the personal authorization device to the approval to grant the authorization to access the resource; and
store the access token for subsequent requests by a client application to access the resource.

3. The method for obtaining a multi-factor certification of an authorization authorizing a client application to access a resource controlled by a particular user and located on a resource server of claim 2 further comprising operating the personal authorization device to:
receive a request message for access to the resource from the client application; and
responding to the request message for access to the resource, by transmitting the access token to the client application.

4. The method for obtaining a multi-factor certification of an authorization authorizing a client application to access a resource controlled by a particular user and located on a resource server of claim 2 further comprising operating the personal authorization device to:
receive a request message for access to the resource from the client application;
performing a prescribed cryptographic operation on the request message using a secret of the access token thereby producing a cryptographic result; and
responding to the request for access to the resource, by transmitting the cryptographic result to the client application.

5. The method for obtaining a multi-factor certification of an authorization authorizing a client application to access a resource controlled by a particular user and located on a resource server of claim 1 wherein the personal authorization device is selected from the set including a smart card, a secure element, a smart memory device, and a mobile device with a secure element.

6. The method for obtaining a multi-factor certification of an authorization authorizing a client application to access a resource controlled by a particular user and located on a resource server of claim 1 wherein the authentication of the user to the personal authorization device comprises operating the personal authorization device to request the user to enter a personal identification number (PIN), a shared secret, a password, or biometrics.

7. The method for obtaining a multi-factor certification of an authorization authorizing a client application to access a resource controlled by a particular user and located on a resource server of claim 1 wherein the authentication of the user to the personal authorization device comprises operating the personal authorization device to obtain a biometric from the user.

8. The method for obtaining a multi-factor certification of an authorization authorizing a client application to access a resource controlled by a particular user and located on a resource server of claim 1 further comprising:
operating a client-application on a client-computer via a web browser on a host computer, the web browser providing a user interface of the client-application to a user;
operating the client-application to send a request for an authorization code to an authorization server to obtain access to a resource located on a resource server and controlled by a particular user;
sending an authorization-request message from the authorization server to the web browser executing on the host computer indicating to the particular user that the client application is requesting authorization to use the resource;
operating the web browser to obtain an indication from the user that the user approval to granting the authorization for the client to access the resource; and
upon receiving the indication from the user that the user approves to granting authorization for the client to access the resource, operating the web browser to obtain the certification of the approval of the grant by the user from the personal authorization device.

9. A method for obtaining a multi-factor certification of an authorization authorizing a web application operating on a client-computer to access a resource controlled by a particular user and located on a resource server, comprising:
operating a client-application on a client-computer via a web browser on a host computer, the web browser providing a user interface of the client-application to a user;
operating the client-application to send a request for an authorization code to an authorization server to obtain access to a resource located on a resource server and controlled by a particular user;
sending request user authentication from the authorization server to an authentication server;
operating the authentication server to authenticate the particular user and upon successful authentication of the particular user, sending an authentication-OK message to the authorization server;
sending an authorization-request message from the authorization server to the web browser executing on the host computer indicating to the particular user that the client application is requesting authorization to use the resource;
receiving an approval indication from the particular user and upon receiving the approval indication forwarding the authorization-request message to personal authorization device associated with the particular user;
operating the personal authorization device to certify the approval of the particular user to grant authorization to the client application;
forwarding the certification of the user approval of the authorization grant to the authorization server;
operating the authorization server to verify the certification of the user approval of the authorization grant and upon verification of the certification of the user approval of the grant, to send an authorization code to the client application;
operating the client application to transmit an access-token request message including the authorization code to the authorization server;
upon receiving the access-token request message from the client application, operating the authorization server to transmit an access token to the client application authorizing the client application to access the resource;
upon receiving the access token, operating the client application to transmit a request-resource message to the resource server including the access token; and
upon receiving the request-resource message, operating the resource server to grant the client application access to the requested resource.

10. A personal authorization device having a processor and a memory, the personal authorization device comprising instructions stored in the memory, the instructions causing the processor to:
receive a message indicating that a user associated with the personal security device has authorized a client application requests to access a protected resource hosted on a resource server;
verify via a web browser on a host computer to which the personal security device is connected that the user desires to grant the requested authorization by authenticating the user;
upon verifying that the user approves the requested authorization grant, performing a cryptographic signature on the message thereby producing a cryptographic result;
transmitting the cryptography result to an authorization server indicating to the user has approved granting authorization to access the protected resource.

11. The personal authorization device of claim 10 further comprising instructions stored in the memory to cause the processor to:
receive an access token from the authorization server;
store the access token; and
transmit the access token to the client application when requested to do so.

12. The personal authorization device of claim 10 further comprising instructions stored in the memory to cause the processor to:
receive an access token from the authorization server;
store the access token;
receive a resource request message from the client application;
perform a cryptographic process on the request message using a secret of the access token thereby producing a cryptographic result;
to transmit the cryptographic result to the resource server.

13. The personal authorization device of claim 10 wherein the personal authorization device is selected from the set including a smart card, a secure element, a smart memory device, a mobile device with a secure element.

14. The personal authorization device of claim 10 wherein the instructions authenticating the user comprises instructions to cause the processor to request the user to enter a personal identification number (PIN), a shared secret, or a password.

15. The personal authorization device of claim 10 wherein the instructions authenticating the user comprises instructions to cause the processor to request the user to obtain a biometric from the user.
